(19) United States
(12) Patent Application Publication
(10) Pub. No.: US 2018/0105129 A1
(43) Pub. Date: Apr. 19, 2018

(54) BUMPER REINFORCEMENT FOR VEHICLE

(71) Applicants: AISIN SEIKI KABUSHISIKI KAISHA, Kariya-shi (JP); AISIN KEIKINZOKU KABUSHIKI KAISHA, Imizu-shi (JP)

(72) Inventors: Kohei HODOYA, Novi, MI (US); Kiyoichi KITA, Okazaki-shi (JP); Tamaki OBAYASHI, Toyama-shi (JP); Jun SHOBO, Anjo-shi (JP)

(73) Assignees: AISIN SEIKI KABUSHISIKI KAISHA, Kariya-shi (JP); AISIN KEIKINZOKU KABUSHIKI KAISHA, Imizu-shi (JP)

(21) Appl. No.: 15/787,243

(22) Filed: Oct. 18, 2017

(30) Foreign Application Priority Data
Oct. 19, 2016 (JP) 2016-205088

(51) Int. Cl. B60R 19/18; B60R 19/03

(52) U.S. Cl. CPC B60R 19/18; B60R 2021/0004; B60R 19/03

(57) ABSTRACT

A bumper reinforcement for a vehicle includes: a body portion extending in a vehicle width direction and having an inner space extending in the vehicle width direction, the body portion being open at its side surface on a passenger compartment side in order to allow a pair of side members extending in a vehicle longitudinal direction to be inserted into the inner space from the passenger compartment side; and a reinforcing portion made of a carbon fiber-reinforced resin and bonded to an intermediate portion in the vehicle width direction of the body portion, the intermediate portion located between the pair of side members.

### INCORPORATION BY REFERENCE

The disclosure of Japanese Patent Application No. 2016-205088 filed on Oct. 19, 2016 including the specification, drawings and abstract is incorporated herein by reference in its entirety.

### BACKGROUND

### 1. Technical Field

The disclosure relates to a bumper reinforcement for a vehicle.

### 2. Description of Related Art

As described in Japanese Patent No. 5342999 or Japanese Patent No. 5689034, there is known a vehicle bumper reinforcement that absorbs impact when an object collides with a front end (or a rear end) of a vehicle during the travel of the vehicle. The vehicle bumper reinforcement is provided to extend in a vehicle width direction. The vehicle bumper reinforcement includes a first wall portion, a second wall portion, and a third wall portion. The first wall portion is disposed in front of (or in the rear of) a passenger compartment and extends in the vehicle width direction with its wall surface facing the side opposite to the passenger compartment. The second wall portion and the third wall portion each extend in the vehicle width direction and respectively extend from upper and lower ends of the first wall portion toward the passenger compartment side. That is, the vehicle bumper reinforcement is open at its side surface on the passenger compartment side. Accordingly, when an object collides with the front end (or the rear end) of the vehicle to which the vehicle bumper reinforcement is applied, an impact load is applied to the vehicle bumper reinforcement so that the vehicle bumper reinforcement is gradually deformed. Thus, the impact is absorbed. In this event, the second wall portion and the third wall portion serve as reinforcing ribs for the first wall portion.

### SUMMARY

Since the vehicle bumper reinforcement of the related art is open at its side surface on the passenger compartment side, there is a possibility that, as shown in FIG. 5, the passenger compartment side of the vehicle bumper reinforcement may be opened at an initial stage of the deformation of the vehicle bumper reinforcement. After the passenger compartment side of the vehicle bumper reinforcement is opened, the second wall portion and the third wall portion do not serve as the reinforcing ribs for the first wall portion so that the impact load that can be withstood by the vehicle bumper reinforcement decreases. In other words, only with the application of a relatively small impact load, the deformation of the vehicle bumper reinforcement proceeds. Therefore, in this case, the impact absorption performance of the vehicle bumper reinforcement is low. That is, the impact absorption amount of the vehicle bumper reinforcement is small. Incidentally, in order to suppress the opening of the passenger compartment side of the vehicle bumper reinforcement so as to increase the impact absorption amount, the vehicle bumper reinforcement may be formed tubular, for example. However, in this case, the weight of the vehicle bumper reinforcement increases. Alternatively, the thickness of the respective wall portions forming the vehicle bumper reinforcement may be increased, for example. However, also in this case, the weight of the vehicle bumper reinforcement increases.

The disclosure provides a bumper reinforcement for a vehicle, which is improved in its impact absorption performance. In order to facilitate understanding of the disclosure, symbols of corresponding portions of an embodiment are described for constituent features of the disclosure below. However, the constituent features of the disclosure should not be interpreted to be limited to the configurations of the corresponding portions denoted by the symbols of the embodiment.

A bumper reinforcement for a vehicle according to an aspect of the disclosure includes: a body portion extending in a vehicle width direction in front of or in rear of a passenger compartment and having an inner space extending in the vehicle width direction, the body portion being open at its side surface on a passenger compartment side in order to allow a pair of side members respectively extending in a vehicle longitudinal direction on both sides in the vehicle width direction of the vehicle to be inserted into the inner space from the passenger compartment side; and a reinforcing portion made of a carbon fiber-reinforced resin and bonded to an intermediate portion in the vehicle width direction of the side surface on the passenger compartment side of the body portion, the intermediate portion located between the pair of side members. In the above-described aspect, the reinforcing portion may be provided at a middle portion in the vehicle width direction of the body portion.

In the above-described aspect, the reinforcing portion may contain carbon fibers that are respectively oriented in a longitudinal direction of the body portion and a vehicle height direction.

When an object collides, from the side opposite to the passenger compartment, with a middle portion in the vehicle width direction of the vehicle to which the vehicle bumper reinforcement is applied, a middle portion in the vehicle width direction of the vehicle bumper reinforcement starts to be bent. In this event, forces (compressive forces) toward the middle portion in the vehicle width direction of the body portion act on a portion, located on the side opposite to the passenger compartment, of the middle portion in the vehicle width direction of the body portion (see FIG. 4). On the other hand, forces (tensile forces) toward both end sides in the vehicle width direction of the body portion act on a portion, located on the passenger compartment side, of the middle portion in the vehicle width direction of the body portion. Further, forces to open the passenger compartment side of the middle portion in the vehicle width direction of the body portion act on the body portion (see FIG. 5).

In the disclosure, the reinforcing portion made of the carbon fiber-reinforced resin is bonded to the side surface on the passenger compartment side of the body portion. Consequently, the rigidity against the tensile forces that act on the portion, located on the passenger compartment side, of the middle portion in the vehicle width direction of the body portion is enhanced, and simultaneously, the rigidity against the forces to open the passenger compartment side of the middle portion in the vehicle width direction of the body portion is enhanced. Particularly, when the carbon fibers are oriented in the width direction (the longitudinal direction of the body portion) and the length direction (the vehicle height direction) in the reinforcing portion, both rigidities described above are effectively enhanced. Therefore, the impact absorption performance of the vehicle bumper reinforcement can be improved without forming the body portion in a tubular shape (a shape in which its side surface portion on the passenger compartment side is closed). Further, the impact absorption performance of the vehicle bumper reinforcement can be improved while keeping the wall thickness of the body portion equal to that of the related art.

In general, a vehicle bumper reinforcement is attached to framework members (side members) of a vehicle. When an object collides with the vehicle, front end portions of the side members (or crash boxes provided at the front end portions of the side members) are compressively deformed in the vehicle longitudinal direction. The impact is partially absorbed by this. Therefore, it is preferable that a portion, which can be compressively deformed in the vehicle longitudinal direction at the time of a collision, of each of the side members be set as long as possible. That is, it is preferable to set the compression stroke as long as possible. When the body portion is tubular, the front end portions of the side members cannot be inserted into the vehicle bumper reinforcement. Therefore, in this case, front end faces of the side members are fastened to a rear surface of the body portion. In contrast, in the disclosure, the side surface on the passenger compartment side of the body portion is open, and the reinforcing portion is bonded to the intermediate portion in the vehicle width direction of the side surface on the passenger compartment side of the body portion, the intermediate portion located between the pair of side members. That is, the side surface on the passenger compartment side of the body portion is open toward the passenger compartment side at its both end portions in the vehicle width direction. Accordingly, the front end portions of the side members each can be inserted into the vehicle bumper reinforcement through this opening. Therefore, a portion, which can be compressively deformed in the vehicle longitudinal direction at the time of a collision, of each of the side members can be set longer than the case where the body portion is tubular.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a plan view of a vehicle to which a vehicle bumper reinforcement according to the disclosure is applied;

FIG. 2 is an exploded perspective view of the vehicle bumper reinforcement;

FIG. 3 is a cross-sectional view of the vehicle bumper reinforcement perpendicular to its longitudinal direction;

FIG. 4 is a schematic diagram showing a direction of a load (stress) that acts on the vehicle bumper reinforcement; and

FIG. 5 is a schematic diagram showing a state in which the passenger compartment side of a vehicle bumper reinforcement of a related art is opened.

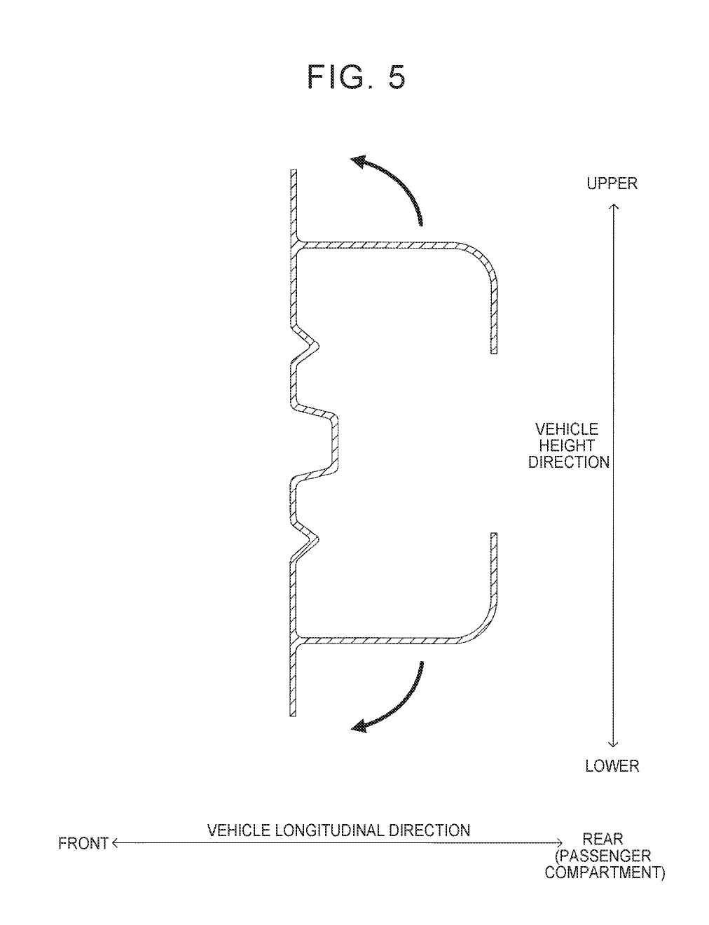

### DETAILED DESCRIPTION OF EMBODIMENTS

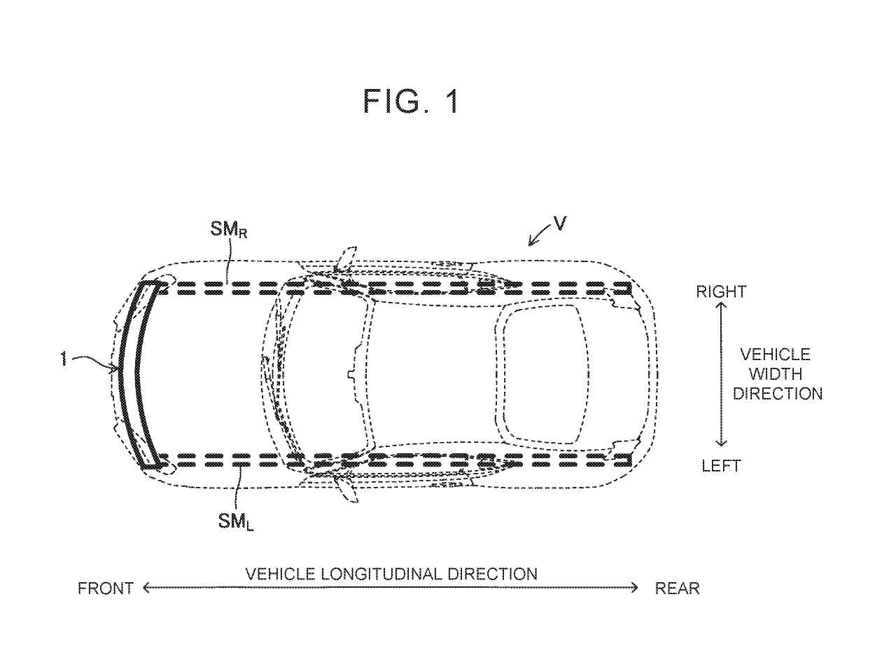

A vehicle bumper reinforcement 1 according to an embodiment of the disclosure will be described. First, a vehicle V to which the vehicle bumper reinforcement 1 is applied will be schematically described. As shown in FIG. 1, the vehicle V includes a pair of right and left side members SM_{R}, SM_{L} and the vehicle bumper reinforcement 1.

The side members SM_{R}, SM_{L} are respectively disposed on both sides in a vehicle width direction. The side members SM_{R}, SM_{L} are each formed in a rectangular tubular shape extending in a vehicle longitudinal direction. The side members SM_{R}, SM_{L} are each provided at its front end face with a flange portion. The vehicle bumper reinforcement 1 is attached to the flange portions of the side members SM_{R}, SM_{L}.

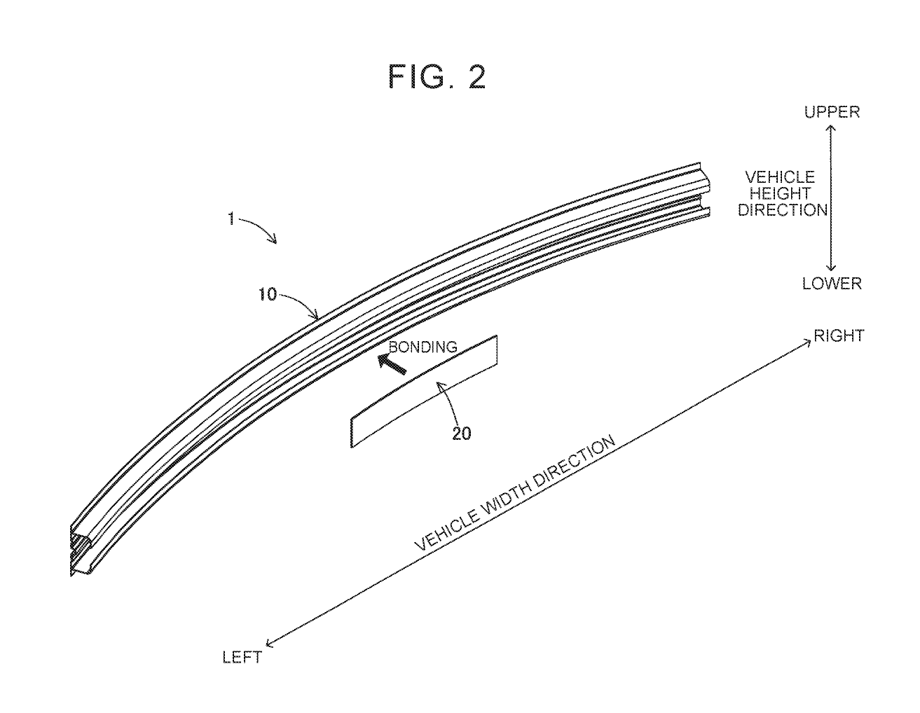

Next, the configuration of the vehicle bumper reinforcement 1 will be described in detail. As shown in FIG. 2, the vehicle bumper reinforcement 1 includes a body portion 10 and a reinforcing portion 20.

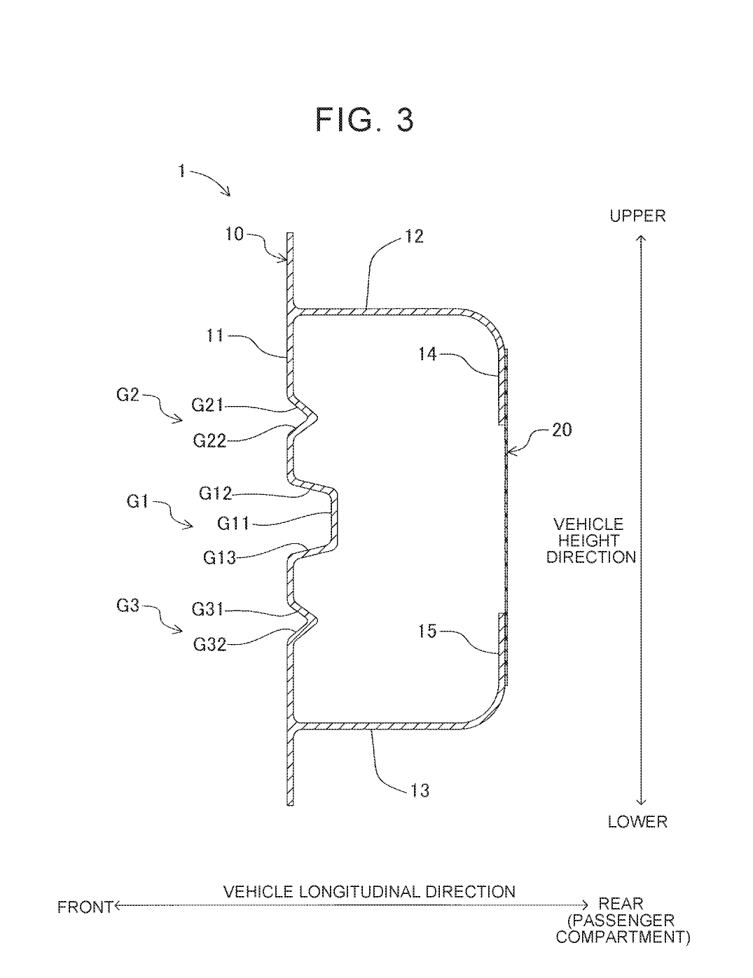

The body portion 10 is made of an aluminum alloy. The body portion 10 extends in the vehicle width direction. The body portion 10 has a space therein and is open at its side surface (rear surface) on the passenger compartment side. In plan view, the body portion 10 is curved in an arc shape (see FIG. 1). That is, both end portions in the vehicle width direction of the body portion 10 are located slightly rearward of a middle portion in the vehicle width direction of the body portion 10. The curvature of the body portion 10 is determined based on a design of a front end portion (a shape of a bumper cover) of the vehicle V. As shown in FIG. 3, the body portion 10 has a front wall portion 11, an upper wall portion 12, a lower wall portion 13, an upper rear wall portion 14, and a lower rear wall portion 15.

The front wall portion 11 is formed in a plate shape and extends in the vehicle width direction with its wall surface (front surface) facing the side opposite to the passenger compartment. A middle portion in a vehicle height direction of the front wall portion 11 is recessed rearward. That is, a groove portion G1 extending in a longitudinal direction of the front wall portion 11 is formed at the middle portion in the vehicle height direction of the front wall portion 11. The groove portion G1 has a bottom wall portion G11 parallel to the vehicle height direction, and an upper side wall portion G12 and a lower side wall portion G13 respectively extending forward from upper and lower ends of the bottom wall portion G11.

Further, a groove portion G2 extending in the longitudinal direction of the front wall portion 11 is formed at a portion slightly above the groove portion G1 in the front wall portion 11. The groove portion G2 has an upper side wall portion G21 directed obliquely downward and a lower side wall portion G22 directed obliquely upward. A lower edge of the upper side wall portion G21 and an upper edge of the lower side wall portion G22 are connected to each other.

Further, a groove portion G3 extending in the longitudinal direction of the front wall portion 11 is formed at a portion slightly below the groove portion G1 in the front wall portion 11. The groove portion G3 has an upper side wall portion G31 directed obliquely downward and a lower side wall portion G32 directed obliquely upward. A lower edge of the upper side wall portion G31 and an upper edge of the lower side wall portion G32 are connected to each other.

The upper wall portion 12 extends rearward from a portion slightly above the groove portion G2 in the front wall portion 11. The lower wall portion 13 extends rearward from a portion slightly below the groove portion G3 in the front wall portion 11. The upper rear wall portion 14 extends downward from a rear end of the upper wall portion 12. A connecting portion between the upper wall portion 12 and the upper rear wall portion 14 is bent. The lower rear wall portion 15 extends upward from a rear end of the lower wall portion 13. A connecting portion between the lower wall portion 13 and the lower rear wall portion 15 is bent. An upper end face of the lower rear wall portion 15 faces a lower end face of the upper rear wall portion 14.

The body portion 10 is provided with various non-illustrated through-holes (e.g. holes into which fastening members (rivets, bolts, etc.) for fastening the vehicle bumper reinforcement 1 to the side members SM_{R}, SM_{L} are inserted).

The body portion 10 is formed in the following manner. First, an aluminum alloy material is extruded to form a straight intermediate molded body. An extrusion direction of the metal material corresponds to the vehicle width direction. That is, the intermediate molded body extends in the vehicle width direction. A cross section perpendicular to a longitudinal direction of the intermediate molded body presents the same shape as that shown in FIG. 3. That is, the intermediate molded body has wall portions corresponding to the front wall portion 11, the upper wall portion 12, the lower wall portion 13, the upper rear wall portion 14, and the lower rear wall portion 15. Then, the intermediate molded body is bent into an arc shape (see FIG. 1). Thereafter, the above-described various through-holes are formed in the intermediate molded body. In this way, the body portion 10 is formed.

The reinforcing portion 20 is made of a carbon fiber-reinforced resin. The reinforcing portion 20 is formed in a thin plate shape extending in the vehicle width direction. One of plate surfaces of the reinforcing portion 20 faces forward. The reinforcing portion 20 is curved along the rear surface of the middle portion in the vehicle width direction of the body portion 10. The dimension in a longitudinal direction of the reinforcing portion 20 is smaller than that in a longitudinal direction of the body portion 10. The dimension in the vehicle height direction of the reinforcing portion 20 (the dimension in a direction perpendicular to the longitudinal direction and a thickness direction of the reinforcing portion 20) is slightly smaller than that in the vehicle height direction of the body portion 10 at its rear end. A sheet (or a member formed by stacking a plurality of sheets each) formed by weaving carbon fibers that are oriented in a width direction (the longitudinal direction of the body portion 10) and a length direction (the vehicle height direction) is impregnated with a synthetic resin material and then cured, thereby forming the reinforcing portion 20. As shown in FIG. 2, the reinforcing portion 20 is bonded to middle portions in the vehicle width direction of the upper rear wall portion 14 and the lower rear wall portion 15 of the body portion 10 (between the side members SM_{R}, SM_{L}).

Front end portions of the side members SM_{R}, SM_{L} are inserted into the vehicle bumper reinforcement 1 from the rear of both end portions in the vehicle width direction of the vehicle bumper reinforcement 1. Then, in the state where front end faces of the side members SM_{R}, SM_{L} are in contact with a rear surface of the front wall portion 11 of the vehicle bumper reinforcement 1, the vehicle bumper reinforcement 1 and the side members SM_{R}, SM_{L} are fastened together.

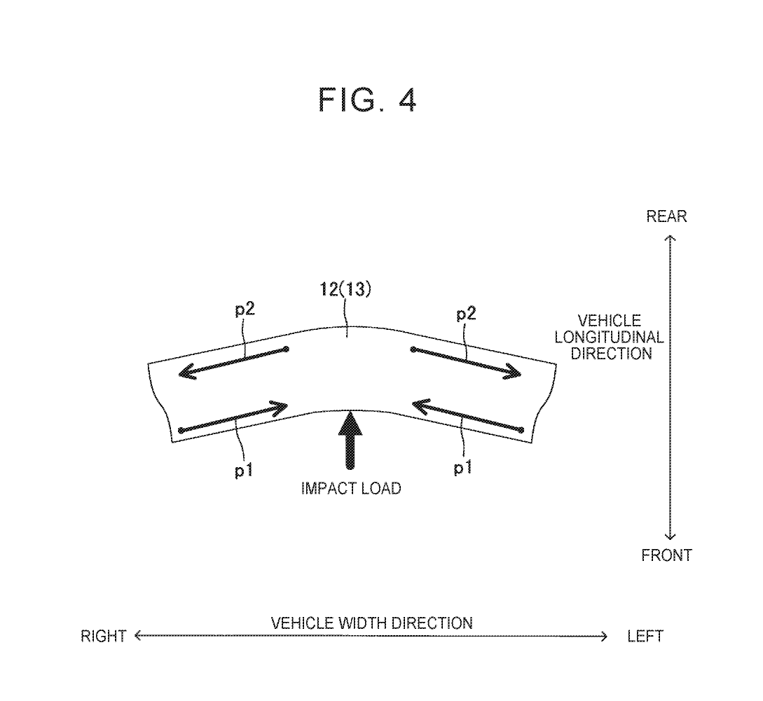

As shown in FIG. 4, when an object collides, from the front, with a middle portion in the vehicle width direction of the vehicle V to which the vehicle bumper reinforcement 1 is applied, an impact load acts on a middle portion in the vehicle width direction of the vehicle bumper reinforcement 1. Consequently, the middle portion in the vehicle width direction of the vehicle bumper reinforcement 1 is pressed rearward so that the vehicle bumper reinforcement 1 starts to be bent. In this event, forces (compressive forces p1) toward the middle portion in the vehicle width direction of the body portion 10 act on a front portion of the middle portion in the vehicle width direction of the body portion 10. On the other hand, forces (tensile forces p2) toward both end sides in the vehicle width direction of the body portion 10 act on a rear portion of the middle portion in the vehicle width direction of the body portion 10. Further, forces to open the rear portion of the middle portion in the vehicle width direction of the body portion 10 act on the body portion 10.

In this embodiment, the reinforcing portion 20 is provided on the rear surface of the middle portion in the vehicle width direction of the body portion 10. In the reinforcing portion 20, the carbon fibers are oriented in the width direction (the longitudinal direction of the body portion 10) and the length direction (the vehicle height direction). Since the carbon fibers are oriented in the width direction and the length direction in this way, the rigidity against the tensile forces p2 in the vehicle width direction that act on the rear portion of the middle portion in the vehicle width direction of the body portion 10 is enhanced, and simultaneously, the rigidity against the forces to open the rear portion of the body portion 10 is enhanced. Therefore, the impact absorption performance of the vehicle bumper reinforcement 1 can be improved without forming the body portion 10 in a tubular shape (a shape in which its side surface portion on the passenger compartment side is closed). Further, the impact absorption performance of the vehicle bumper reinforcement 1 can be improved while keeping the wall thickness of the body portion 10 equal to that of the related art. That is, while the weight of the vehicle bumper reinforcement 1 is equal to that of the vehicle bumper reinforcement of the related art, the impact absorption performance of the vehicle bumper reinforcement 1 is higher than that of the vehicle bumper reinforcement of the related art.

In this embodiment, the body portion 10 is manufactured using the extrusion molding method. Since the body portion 10 is open at its rear surface in this embodiment, the structure of a die for extrusion molding is simple compared to the case where the body portion 10 is tubular. Further, the body portion 10 can be formed relatively easily.

When an object collides from the front of the vehicle V, the front end portions of the side members SM_{R}, SM_{L} are compressively deformed in the vehicle longitudinal direction. The impact is partially absorbed by this. Therefore, it is preferable that a portion, which can be compressively deformed in the vehicle longitudinal direction at the time of a collision, of each of the side members SM_{R}, SM_{L} be set as long as possible. That is, it is preferable to set the compression stroke as long as possible. When the body portion 10 is tubular, the front end portions of the side members SM_{R}, SM_{L} cannot be inserted into the vehicle bumper reinforcement 1. Therefore, in this case, the front end faces of the side members SM_{R}, SM_{L} are fastened to a rear surface of the body portion 10. In contrast, in this embodiment, the rear surface of the body portion 10 is open, and the reinforcing portion 20 is bonded to only the middle portion in the vehicle width direction of the rear surface of the body portion 10. That is, the rear surface of the body portion 10 is open at its both end portions in the vehicle width direction. Accordingly, the front end portions of the side members SM_{R}, SM_{L} each can be inserted into the vehicle bumper reinforcement 1 through this opening. Therefore, a portion, which can be compressively deformed in the vehicle longitudinal direction at the time of a collision, of each of the side members SM_{R}, SM_{L} can be set longer than the case where the body portion 10 is tubular.

Further, when carrying out the disclosure, the disclosure is not limited to the above-described embodiment, but various changes can be made within a range not departing from the gist of the disclosure.

For example, while the reinforcing portion 20 is bonded to the body portion 10 in the vehicle bumper reinforcement 1, the reinforcing portion 20 may be fixed to the body portion 10 using bolts, rivets, or the like. In this case, holes for inserting the bolts, the rivets, or the like may be formed in the reinforcing portion 20, and a collar (annular member) for reinforcing the peripheral edge of the hole may be disposed around each hole.

What is claimed is:

1. A bumper reinforcement for a vehicle, comprising:
a body portion extending in a vehicle width direction in front of or in rear of a passenger compartment and having an inner space extending in the vehicle width direction, the body portion being open at its side surface on a passenger compartment side in order to allow a pair of side members respectively extending in a vehicle longitudinal direction on both sides in the vehicle width direction of the vehicle to be inserted into the inner space from the passenger compartment side; and
a reinforcing portion made of a carbon fiber-reinforced resin and bonded to an intermediate portion in the vehicle width direction of the side surface on the passenger compartment side of the body portion, the intermediate portion located between the pair of side members.

2. The bumper reinforcement according to claim 1, wherein the reinforcing portion is provided at a middle portion in the vehicle width direction of the body portion.

3. The bumper reinforcement according to claim 2, wherein the reinforcing portion contains carbon fibers that are respectively oriented in a longitudinal direction of the body portion and a vehicle height direction.

4. The bumper reinforcement according to claim 1, wherein the reinforcing portion contains carbon fibers that are respectively oriented in a longitudinal direction of the body portion and a vehicle height direction.
